(19) United States
(12) Patent Application Publication
(10) Pub. No.: US 2024/0389511 A1
(43) Pub. Date: Nov. 28, 2024

(54) SWATHER

(71) Applicant: MASCHINENFABRIK BERNARD KRONE GMBH & CO. KG, SPELLE (DE)

(72) Inventors: ERIK HELPER, Quendorf (DE); Andreas Afting, Emsbueren (DE)

(73) Assignee: MASCHINENFABRIK BERNARD KRONE GMBH & CO. KG, SPELLE (DE)

(21) Appl. No.: 18/673,370

(22) Filed: May 24, 2024

(30) Foreign Application Priority Data
May 26, 2023 (DE) 10 2023 113 952.5

(51) Int. Cl. A01D 78/10

(52) U.S. Cl. CPC A01D 78/1007

(57) ABSTRACT

A swather includes a frame, a chassis which supports the frame, at least one processing member which is connected at least indirectly to the frame, a front coupling device which is arranged at a front side of the frame with respect to a longitudinal axis of the swather, and a rear coupling device which is arranged at a rear side of the frame with respect to the longitudinal axis. The at least one processing member grips a crop material. The front coupling device defines a front coupling point for attaching the swather to a tractor. The rear coupling device defines a rear coupling point for attaching a baler to the swather.

### CROSS REFERENCE TO PRIOR APPLICATIONS

Priority is claimed to German Patent Application No. DE 10 2023 113 952.5, filed May 26, 2023. The entire disclosure of said application is incorporated by reference herein.

### FIELD

The present invention relates to a swather.

### BACKGROUND

Crops such as grass are usually harvested and processed in several stages. The crop is first mowed with a mowing machine, after which it is either simply left lying around or, for example, spread and/or turned over in the field to improve drying. At a later stage, possibly when the crop has dried, the crop can be picked up and processed into crop bales. This is performed in two steps. The crop distributed on the field is first gathered into a swath using a swather. Common swathers, such as rotary rakes, are typically pulled by a tractor, which also provides the drive power for the swather's processing elements, for example, via a PTO shaft. The tractor's route determines the course of the resulting swath. A baler, for example, a round baler, is used to pick up and compress the crop. Such balers can be self-propelled or pulled by a tractor. The tractor can in turn provide the drive power for the feeding, pressing, and binding elements of the round baler. In the classic process sequence, the field must therefore be driven over three times. While a time interval between mowing and swathing often makes sense to allow the crop to dry, swathing and baling can always immediately follow each other. This means that a first combination of a first tractor and a swather can be immediately followed by a second combination of a second tractor and a baler. However, this requires two tractors. Valuable time may, however, be lost if a single tractor is first used to pull the swather across the first and thereafter the round baler.

### SUMMARY

An aspect of the present invention is to provide an efficient swathing of harvested crop and a further processing of the harvested crop into bales.

In an embodiment, the present invention provides a swather which includes a frame, a chassis which supports the frame, at least one processing member which is connected at least indirectly to the frame, a front coupling device which is arranged at a front side of the frame with respect to a longitudinal axis of the swather, and a rear coupling device which is arranged at a rear side of the frame with respect to the longitudinal axis. The at least one processing member is configured to grip a crop material. The front coupling device defines a front coupling point for attaching the swather to a tractor. The rear coupling device defines a rear coupling point for attaching a baler to the swather.

### BRIEF DESCRIPTION OF THE DRAWINGS

The present invention is described in greater detail below on the basis of embodiments and of the drawings in which:

FIG. 1 shows a top view of a swather according to the present invention;

FIG. 2 shows a side view of the swather from FIG. 1;

FIG. 3 shows a sectional view corresponding to line III-III in FIG. 2; and

FIG. 4 shows a top view of a combination with a tractor, the swather from FIG. 1, and a baler.

### DETAILED DESCRIPTION

The present invention provides a swather with a frame, a chassis for supporting the frame, at least one processing member connected at least indirectly to the frame for picking up harvested material, and a front coupling device which is arranged at the front of the frame with respect to a longitudinal axis of the swather, which front coupling device defines a front coupling point for attaching the swather to a tractor.

The swather is designed to pick up crops lying on the ground, in particular stalks such as grass or hay, via at least one processing element and to merge them into a swath. The at least one processing member is connected to the frame either directly or indirectly, i.e., via at least one intermediate element. The at least one processing element forms the part of the swather that actively interacts with the crop. The at least one processing element can, for example, be arranged movably on the swather frame and can in particular be driven relative to the frame. The driven movement is used to move the crop, the crop thereby being merged, whereby the movement of the swather along the field creates an elongated swath. The frame forms the basic structural framework of the swather and provides stability thereto. Other components of the swather are accordingly fixed or movably arranged on the frame. With regard to the frame, a longitudinal axis pointing backwards against the direction of travel, a transverse axis pointing to the right when viewed in the direction of travel, and an upward-pointing vertical axis of the swather can be defined. A chassis, which is connected to the frame, serves to support the frame. For stability reasons, the chassis advantageously has at least one axle and at least two wheels offset from each other along the transverse axis. An auxiliary chassis can also be provided to support the at least one processing element.

With respect to the longitudinal axis of the swather, a front coupling device is arranged at the front of the frame, the front coupling device defining a front coupling point for attaching the swather to a tractor. The front coupling device can be fully or partially integrated into the frame and in particular be fully or partially integral therewith. For stability reasons, the front coupling device can, for example, be at least rigidly connectable to the frame or also permanently rigidly connected to the frame, for example, welded, bolted or riveted. The front coupling device is designed to establish a connection to the tractor so that the tractor can pull the swather. The front coupling device accordingly defines the front coupling point, whereby the term “point” is of course not to be understood in a mathematical sense, but refers to a certain area which is, however, small compared to the dimensions of the entire swather and is therefore “point-like”. The front coupling device is designed to interact with a complementary coupling device on the side of the tractor. A coupling mouth can, for example, be provided that interacts with a ball head coupling on the tractor side. The coupling point is generally the area in which the power is transmitted between the tractor and the swather when coupled.

The present invention provides that a rear coupling device is arranged at the rear of the frame with respect to the longitudinal axis, the rear coupling device defining a rear coupling point for attaching a baler to the swather. The rear coupling device can be fully or partially integrated into the frame, however, it is also possible for the rear coupling device to in particular form a separate component or assembly that is connected to the frame. The rear coupling device can, for example, be at least rigidly connectable to the frame; the rear coupling device can also be lockable relative to the frame. The rear coupling device is designed to establish a connection to a baler so that the baler can be attached to the swather. The rear coupling device accordingly defines the rear coupling point, whereby the term “point” is again to be understood in the sense explained above. The rear coupling device is designed to interact with a complementary coupling device on the side of the baler. The rear coupling device can, for example, have a ball head coupling which interacts with a coupling jaw on the side of the baler. The rear coupling device therefore allows the baler to be attached to the swather so that it can be pulled indirectly by the tractor while the tractor is pulling the swather. It is understood that both the coupling devices and their connections to the frame, as well as the frame itself, are designed to transmit the pulling force between the tractor and the baler.

The swather of the present invention makes it possible to combine the tractor, the swather, and the baler in a single combination. During field cultivation, the swather picks up the crop lying on the ground via the processing member(s) and gathers the crop into a swath. The baler following within the combination can then pick up the swath and compress it into crop bales. This enables a highly efficient and time-saving processing of the crop when using a single tractor.

The present invention can in principle relate to different types of swathers, for example, star wheel swathers, comb swathers, belt swathers or the like. The swather can, for example, be designed as a rotary rake having at least one raking rotor as a processing member. At least two raking rotors are advantageously provided. The basic structure and mode of operation of a rotary rake are known and are therefore not here discussed in detail. Each raking rotor forms a processing member which interacts with the crop via a plurality of tine arms. Two raking rotors, which are driven in opposite directions, can deposit the crop in a deposit area which is at least partially arranged between the two raking rotors. In a two-rotor swather, exactly two raking rotors are provided. It is also be possible within the scope of the present invention to design, for example, a four-rotor swather or a six-rotor swather, in which case the additional pairs of rotors in particular pick up crops that are further away from the placement area and convey them into the working area of the innermost pair of rotors.

At least one processing element can be arranged on a boom arm connected to the frame. This can in particular apply to a raking rotor of a rotary rake. The processing element can be suspended from the boom arm. A separate boom arm can be provided for each processing element (for example, for each raking rotor), however, it is also possible for a plurality of processing elements to be arranged on a single boom arm. The respective boom arm is in turn connected to the frame. The connection can be rigid or movable. The respective boom arm can in particular be pivotably connected to the frame, for example, to pivot the boom arm with the processing element up into a transport position for road travel and down into a processing position for use in the field. It is also possible for the boom arm to itself be adjustable, for example, extendable, so as to set a different position of the processing element in relation to the frame. The respective boom arm extends at least partially along the transverse axis, referring at least to the above-mentioned processing position. The boom arm can also run parallel to the transverse axis under certain circumstances.

The frame can advantageously have a longitudinal section which extends along the longitudinal axis and connects the front coupling device to the rear coupling device. The longitudinal section is itself rigid and can be formed at least substantially in one piece, for example, via a single profile beam or a single tube. The longitudinal section is essentially responsible for transmitting the tractive forces between the tractor, swather, and baler and must accordingly be stable. The chassis can be connected to a rear area of the longitudinal section, for example, a rear third.

In order to prevent the aforementioned tensile forces from leading to significant bending moments, the longitudinal section can, for example, be arranged as low as possible, approximately at the level of the coupling points. One embodiment of the present invention provides for the longitudinal section to have a ground clearance that is at most 50%, for example, at most 30%, greater than a minimum ground clearance of the coupling points. The minimum ground clearance of the coupling points is the ground clearance of the coupling point that is arranged lowest. If both coupling points have an identical ground clearance, this is the minimum ground clearance. Although this embodiment of the present invention provides that the ground clearance of the longitudinal section is at most 50% or at most 30% greater, this expressly includes the possibility that it is just as large as the minimum ground clearance of the coupling points, or even smaller.

In order to minimize bending moments, it is also advantageous for the longitudinal section to run as straight as possible. In an embodiment of the present invention, the longitudinal section can, for example, runs at an angle of at most 10°, for example, at most 5°, to the longitudinal axis over at least 80% of its length. It can in particular run at an angle of at most 10° or at most 5° to the longitudinal axis over at least 90% of its length or over its entire length. It can also run completely parallel to the longitudinal axis. The longitudinal section can, for example, be formed by a straight profile section or tube.

It is advantageous to arrange the longitudinal section low. A processing element and therefore also a boom arm cannot be moved as far down as desired. The tine arms of a raking rotor must, for example, have a certain minimum distance from the ground in order to provide effective operation. In an embodiment of the present invention, this is taken into account in that at least one boom arm is connected to a boom connection section of the frame, which projects upwards from the longitudinal section with respect to a vertical axis, so that the at least one boom arm is arranged at least predominantly higher than the longitudinal section, at least in the area of the boom connection section. While the longitudinal section extends along a predominant part of the overall length of the swather, the boom connection section can be comparatively short. The boom connection section can in particular extend along at most 20% of the longitudinal section with respect to the longitudinal axis. The boom connection section protrudes from the longitudinal section in relation to the vertical axis. As a result, the boom connection section is at least partially arranged higher. The respective boom arm is connected to this boom connecting section. The boom is accordingly arranged higher than the longitudinal section at least in the area of the boom connecting section, either completely or at least predominantly. The boom arm can in particular be arranged predominantly or even completely higher than the longitudinal section. If the boom arm is pivotably connected to the boom connecting section via a boom swivel axis, the boom swivel axis can, for example, be arranged higher than the longitudinal section, in particular along its entire extension. In this embodiment, in which the boom arm can be swiveled between a swiveled-up transport position and a swiveled-down processing position, the above statements regarding the arrangement of the boom arm refer to the processing position intended for field processing.

In an embodiment of the present invention, the rear coupling device can, for example, be adjustable, whereby the rear coupling point can be displaced relative to the frame with respect to the longitudinal axis. The rear coupling device can be adjusted manually or by an actuator. The rear coupling device can in particular be displaceable relative to the frame. By adjusting the rear coupling device, the rear coupling point can in any case be displaced relative to the frame with respect to the longitudinal axis, i.e., the rear coupling device can be displaced further forwards or further backwards. The rear coupling device can, for example, be displaced parallel to the longitudinal axis so that its position with respect to the transverse axis and the vertical axis does not change. A partial displacement along the transverse axis and/or the vertical axis is, however, also possible. By shifting the rear coupling point, it is possible to adapt to different balers. For example, on a baler with a short drawbar, the coupling point can be moved further to the rear, which reduces the risk of a collision between the baler and swather, for example, when cornering. The position of the rear coupling point can also influence the line of travel of the baler when cornering so that it is possible to avoid a missing part of the swath.

The rear coupling point can, for example, be displaced relative to the chassis with respect to the longitudinal axis. This means that by adjusting the rear coupling device, the relative position of the chassis and rear coupling point can be changed with respect to the longitudinal axis. This also allows the distance between the following baler and the chassis of the swather to be adjusted. A collision between the baler and the chassis can thereby be prevented. This is particularly important if the chassis is arranged at least partially behind the at least one processing member with respect to the longitudinal axis.

It is also conceivable that the rear coupling device is adjustable so that the rear coupling point is displaceable relative to the frame with respect to the transverse axis. If this is possible, in addition to a displacement in relation to the longitudinal axis, the two displacements can, for example, be adjusted independently of each other. By shifting the rear coupling point along the transverse axis, the driving line of the baler in relation to the swather is influenced both when cornering and when driving straight ahead. This has a direct effect on the picking up of the swath by the baler.

The swather can, for example, have an input clutch for the drive connection with a PTO shaft of the tractor and an output clutch which can be coupled to the input clutch in at least a force-transmitting manner and which is designed for the drive connection with the baler. The input clutch can, for example, be arranged on a PTO shaft which can be connected to the tractor's PTO shaft in a suitable manner. This is normally a clutch that is designed for positive engagement with a corresponding clutch on the PTO shaft side. The output clutch is either permanently coupled to the input clutch in a force-transmitting manner or can be coupled thereto at least temporarily in a force-transmitting manner. This means that a drive force and a drive torque generated by the tractor can be transmitted to the output clutch. It is also expressly possible to change the force and/or the torque, for example, via an intermediate gearbox which effects a transmission ratio or reduction ratio. The output clutch can in turn be arranged on a power take-off shaft which can correspond to that of the tractor. This means that the baler can in turn be connected to the output clutch of the swather with a clutch with which it could be connected directly to the tractor. The input clutch and the output clutch could in principle, however, also belong to different clutch systems.

The swather advantageously has a transmission arrangement via which both the at least one processing member and the output clutch can be coupled to the input clutch in at least a force-transmitting manner. In this case “can be coupled in at least a force-transmitting manner” also means either a permanent coupling or a possible temporary coupling. The transmission arrangement therefore provides the drive power of the tractor, which is transmitted via the input clutch, to be split and transmitted to the output clutch (and thus further to the baler) and to the processing element(s). The transmission arrangement accordingly has a transfer gearbox. The transmission arrangement in particular can also have shafts through which the power is transmitted from the transfer gearbox to the output clutch and to the respective processing element. In the case of a rotary rake, for example, a respective boom shaft can be provided which extends from the frame to the area of the boom arm in which the raking rotor is arranged. A longitudinal shaft can also be provided that extends to the output coupling. It is possible that the input clutch and the output clutch are non-rotatably connected to each other by the longitudinal shaft. Alternatively, however, the longitudinal shaft can also be coupled to the input clutch via the intermediate transfer gearbox.

A longitudinal shaft for power transmission from the input clutch to the output clutch can in particular be arranged at least predominantly within the frame, for example, at least predominantly within the longitudinal section. The longitudinal shaft, which can extend over a predominant part of the overall length of the swather, is thereby protected from external influences such as damage or dirt. The arrangement of the longitudinal shaft in the frame can also save space. An arrangement to the side of the frame can, under certain circumstances, limit the space available for the processing elements such as the in particular raking rotors. An arrangement above the frame can mean that the longitudinal shaft must be guided through the boom connection section. An arrangement below the frame may reduce the ground clearance of the swather. The frame and in particular the longitudinal beam typically have such a large cross-section for stability reasons alone that the longitudinal shaft can be easily accommodated therein.

The output coupling can, for example, be connected to the rear coupling device so that the relative position of the output coupling to the rear coupling point with respect to the longitudinal axis is independent of the setting of the rear coupling device. This means that the output coupling is held in a fixed position relative to the rear coupling point via the rear coupling device, at least in relation to the longitudinal axis. This means that regardless of how the rear coupling device is set in relation to the frame, the output coupling and the rear coupling point remain at the same distance from the longitudinal axis. This is advantageous insofar as it makes it possible to always arrange a joint of a cardan shaft, through which the baler is connected to the output coupling, in the same position in relation to the rear coupling point. It is particularly advantageous if the joint is arranged exactly or at least approximately vertically above the rear coupling point, for example, if the distance between the joint and the longitudinal axis and the transverse axis is a maximum of 10 cm or a maximum of 5 cm. Cardan shafts also regularly have telescopic sections for length compensation. Due to frictional forces, however, each length compensation is associated with a load on the cardan shaft. If the positions of the joint and the rear coupling point at least approximately match in relation to the horizontal plane, however, the necessary length compensation is minimized. This has a positive effect on the service life of the drive shaft. Such an arrangement can be achieved with cardan shafts, which balers typically have, in particular by the output coupling being offset forward by between 10 cm and 20 cm in relation to the rear coupling point with respect to the longitudinal axis. More precisely, this statement refers to the part of the output coupling located furthest forward, which is designed to engage with a coupling of the baler.

In addition to the power transmission to the baler via the output coupling, a signal transmission between the baler and the swather can also be provided. A swather control unit and a baler control unit can communicate with each other either wirelessly or in particular by wire. The swather can accordingly have an interface at the rear for signal-transmitting connection with the baler. Information such as measured values can be exchanged via the interface. Control signals can, however, in particular also be transmitted. The round baler can in particular send an adjustment signal to the swather, which then makes an adjustment. Since the swather and the baler are mechanically coupled to each other anyway for tractive force transmission, the control signal can in particular be transmitted by wire. The swather and the baler can in particular be connected via an ISOBUS, via which the baler sends the control signal (digitally) to the swather.

An embodiment of the present invention provides for a braking force that can be exerted on the chassis to be adjustable between a weaker single mode setting, which is adapted to use without a baler, and a stronger combined mode setting, which is adapted to use with a coupled baler. The braking force can, for example, be generated hydraulically or pneumatically, whereby the “braking force that can be applied” corresponds to a possible maximum braking force value. If the swather is used without a baler attached, the swather force that can be applied can be set to the single mode setting, whereby the value can be selected in a similar way to that known in prior art swathers. However, if the baler is attached, the baler rests part of its weight on the swather via the rear coupling device and causes an additional axle load. A higher braking force is accordingly useful for effective braking which can be achieved with the combined mode setting, which is stronger than the single mode setting. This means that effective braking can be achieved when the baler is attached while preventing the wheels of the chassis from locking and damaging the ground, for example, when the baler is not attached. If the braking force that can be applied for road travel can also be set to a road setting or transport setting, the combination mode setting can, for example, be different from the road setting. The road setting is also stronger than the single mode setting as it is not possible to support the working elements via an auxiliary chassis during road transport, which increases the axle load on the (main) chassis. As a rule, however, a different value for the braking force is optimal than for use in the field with the baler attached.

It is conceivable that the adjustment between single mode setting and combined mode setting be carried out by a user, either on the swather itself or via an external input device that is connected to the swather in a signal-transmitting manner, for example, an input device in the tractor. The swather can, however, advantageously be set up to automatically set the combined mode setting when the baler is connected and to automatically set the single mode setting when the baler is not connected. This means that the swather force setting is automatically triggered when the baler is coupled or uncoupled. The braking force can in particular be set as a function of a load on the rear coupling device. A force sensor can, for example, be arranged on the rear coupling device which is connected to a control unit, which in turn is set up to adjust the braking force depending on the measured values of the force sensor.

The present invention is described below with reference to drawings. The drawings are merely exemplary and do not limit the general idea of the present invention.

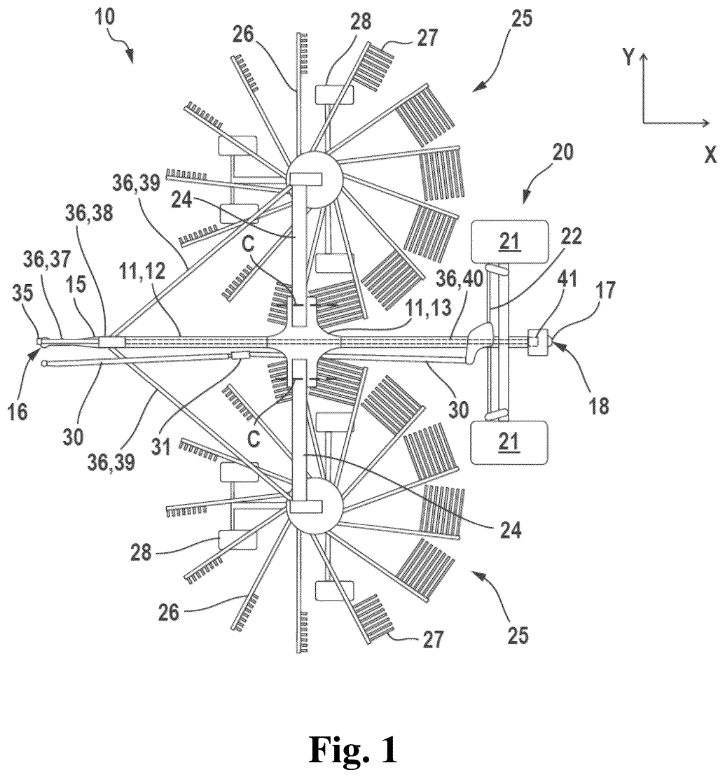

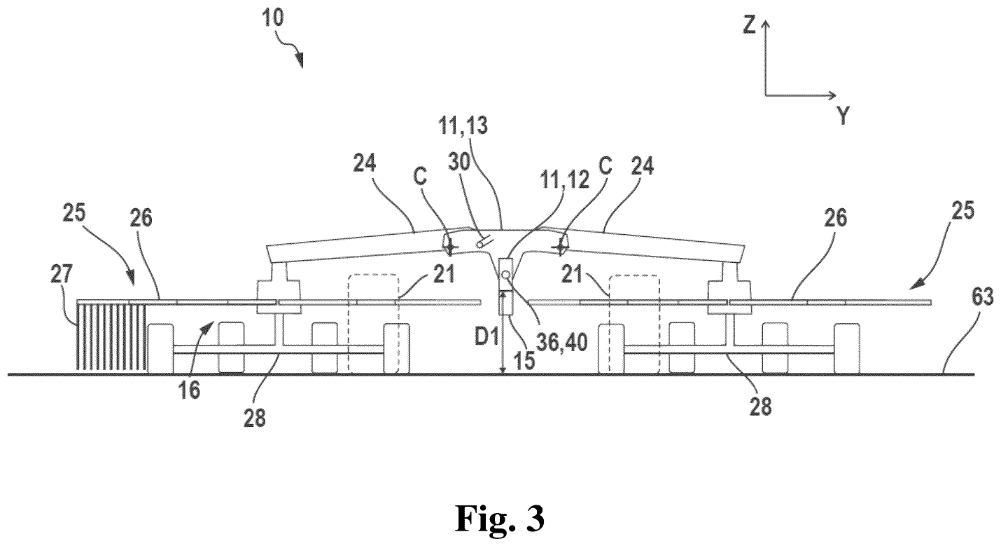

FIGS. 1 to 3 show a swather 10 according to the present invention, more specifically a rotary rake. A longitudinal axis X, a transverse axis Y, and a vertical axis Z of the swather 10 are shown here and in the following drawings. The swather 10 has a frame 11 which is supported against the ground 63 by a chassis 20. The frame 11 is formed for the most part by a longitudinal section 12, which runs parallel to the longitudinal axis X in the form of a tube with a rectangular cross-section. In an area of the longitudinal section 12 that is approximately central with respect to the longitudinal axis X, the frame 11 has a boom connecting section 13 that projects with respect to the vertical axis Z relative to the longitudinal section 12. Two boom arms 24 are connected to the boom connecting section 13, each of which is pivotable about a boom swivel axis C. This makes it possible to swivel the respective boom arm 24 together with a raking rotor 25 arranged thereon from the processing position shown in the drawings into a transport position, which is intended for road transport. The respective raking rotor 25 forms a processing element of the swather 10, with which crop material can be picked up and deposited in a deposit area 64. Each of the raking rotors 25 has a plurality of tine arms 26, to which tines 27 are attached. In the course of the driven rotation of the raking rotor 25, the setting of the tines 27 is changed in a cam track-controlled manner, which is known in the prior art and is not here explained further. In the working position, each raking rotor 25 is supported on the ground 63 by an auxiliary chassis 28.

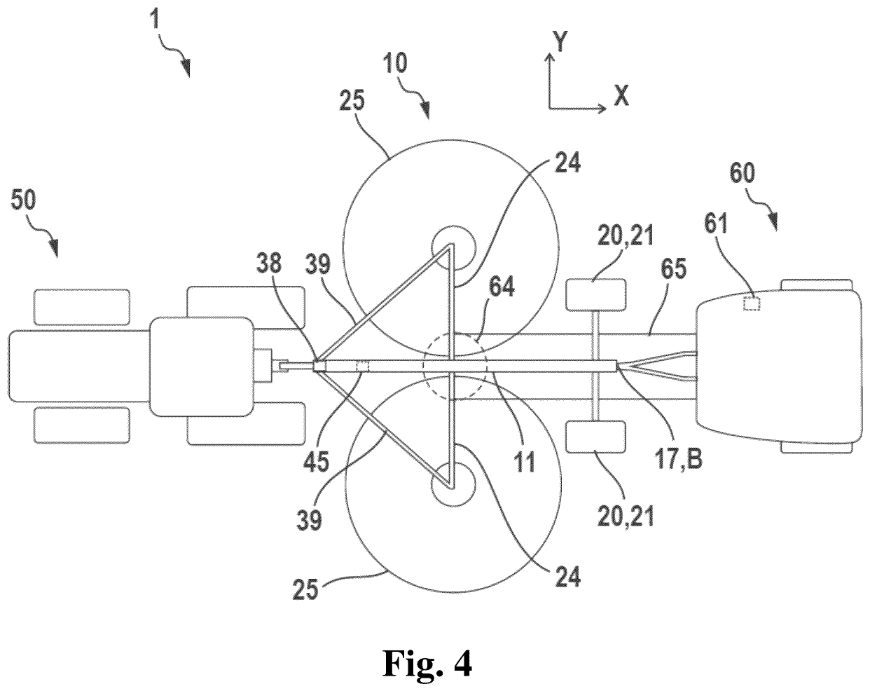

At the front, a front coupling device 15 which has a coupling mouth 16 is attached to the frame 11. The coupling mouth 16 defines a front coupling point A and can interact with a ball head coupling of a tractor 50, which is not shown, so that the swather 10 can be pulled by the tractor 50, which is shown in FIG. 4. A rear coupling device 17 is arranged at the rear of the frame 11 which has a ball head coupling 18. The ball head coupling 18 defines a rear coupling point B which can interact with a coupling jaw of a baler 60, which is here also not shown, whereby the baler 60 can be attached to the swather 10, which is also shown in FIG. 4. The tractor 50, the swather 10, and the baler 60 can thereby form a combination 1. During operation of the combination 1, the raking rotors 25 pick up crop lying on the ground and deposit it in the deposit area 64 (see FIG. 4). The forward movement of the swather 10 creates a swath 65, which is in turn picked up by the baler 60 and pressed into crop bales.

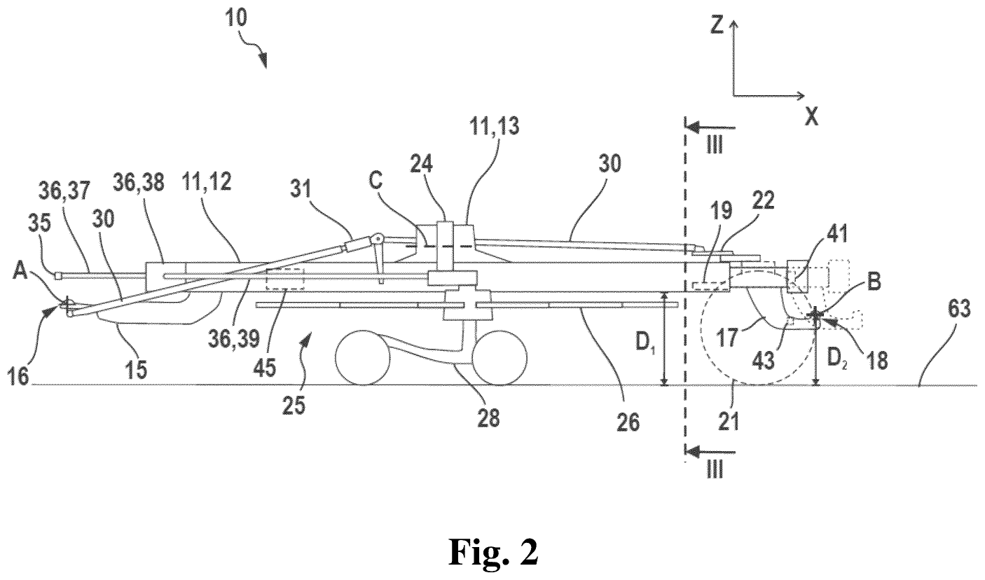

The swather 10 has two steering rods 30, one of which is articulated to the tractor 50 when coupled. As a result, when the tractor 50 is cornering, either a pulling or a pushing force is transmitted via the steering rods 30 to the track rods 22 of the chassis 20 so as to generate a rectified steering movement of the wheels 21 of the chassis 20. As can be seen in particular in FIG. 2, a steering actuator 31 is interposed between the steering rods 30. The steering actuator 31 can be used to change the steering angle of the wheels 21 independently of the movements of the tractor 50.

In addition to the presence of the rear coupling device 17, the swather 10 has various adaptations to the pulling of the baler 60. In order to minimize bending moments acting on the frame 11, which bending moments result from the transmission of the pulling force, the longitudinal section 12, through which the two coupling devices 15, 17 are connected, runs parallel to the longitudinal axis X. The longitudinal section 12 is also arranged low and thus almost at the level of the coupling points A, B. More precisely, a ground clearance D₁ of the longitudinal section 12 in the example shown is only about 30% more than a minimum ground clearance D₂ of the coupling points A, B, which in this case is the ground clearance of the rear coupling point B. Due to the low arrangement of the longitudinal section 12, the boom arms 24 must be connected to the frame 11 via the upwardly extending boom connection section 13. In relation to the vertical axis Z, the boom arms 24 are predominantly arranged higher than the longitudinal section 12. In particular, the boom swivel axes C are arranged higher than the longitudinal section 12.

The swather 10 has an input clutch 35 which serves to interact with a PTO shaft of the tractor 50. A PTO shaft 37 of a gearbox arrangement 36 is connected to the input clutch 35. The PTO shaft 37 opens into a transfer gearbox 38, from which two extension shafts 39, which serve to drive the raking rotors 25, and a longitudinal shaft 40, extend. The longitudinal shaft 40 is guided within the longitudinal section 12 as far as an output clutch 41, which is arranged on the rear coupling device 17. The output clutch 41 can in turn be connected to a cardan shaft of the baler 60 (which is not shown), whereby a driving force of the tractor 50 is transmitted to the baler 60 via the swather 10.

While the front coupling device 15 is rigidly connected to the frame 11, the rear coupling device 17 can be adjusted along the longitudinal axis X via an actuator 19. This is indicated schematically in FIG. 2, in which a position extended further to the rear is shown in short, dashed lines. This adjustment process allows the swather 10 to be adapted to different balers 60. On a baler 60 with a longer drawbar, the rear coupling device 17 can be adjusted further forwards, whereas on a baler 60 with a shorter drawbar, it can be adjusted further backwards, so that the actual vehicle body of the baler 60 can maintain a sufficient distance from the swather 10 and, in particular, from the chassis 20. Collisions can thereby be avoided, in particular when cornering. When cornering, it is also possible to prevent the attached baler 60 from running “off track”, thereby preventing parts of the swath 65 from not being picked up.

The output clutch 41 is connected to the rear coupling device 17 so that its relative position with respect to the rear coupling point B with respect to the longitudinal axis X is independent of the setting of the rear coupling device 17. As a result, a joint of a cardan shaft, through which the baler 60 is connected to the output clutch 41 always remains in the same position with respect to the rear coupling point B. The output clutch 41 can be offset forwards by between 10 cm and 20 cm in relation to the rear coupling point B with respect to the longitudinal axis X. This provides that the joint is arranged at least approximately vertically above the rear coupling point B in a typical PTO shaft of a baler 60. Only slight thrust forces therefore arise within the cardan shaft when cornering.

The swather 10 has a swather control unit 45 which can also, for example, control the actuator 19. The swather control unit 45 is also connected to a force sensor 43 which is shown schematically inside the rear coupling device 17 in FIG. 2. The swather control unit 45 can use the force sensor 43 to detect whether a baler 60 is currently attached or not. If there is no baler 60, the swather control unit 45 sets a possible braking force of the chassis 20 to a weaker single mode setting. If a baler 60 is attached, the swather control unit 45 sets the braking force to a stronger combined mode setting. This prevents the wheels 21 from locking when there is no baler 60 and, when a baler 60 is attached, to provide sufficient braking force that is adapted to the higher axle load of the chassis 20.

The swather control unit 45 can also control the steering actuator 31, whereby a steering angle of the chassis 20 can be influenced independently of the tractor 50. This can be used, for example, to influence the line of travel and/or alignment of the swather 10 in relation to the tractor 50. The swather control unit 45 can in turn receive external control signals for this purpose. The control signals can, for example, be transmitted by the tractor 50. It would also be possible, however, for a baler control unit 61 of the baler 60 to transmit the control signals. In order to provide a corresponding data transmission, the swather 10 can have a wired interface in the rear area of the frame 11 which is connected to a corresponding interface of the baler 60, for example, in accordance with the ISOBUS standard.

The present invention is not limited to embodiments described herein; reference should be had to the appended claims.

### LIST OF REFERENCE CHARACTERS

1 Combination
10 Swather
11 Frame
12 Longitudinal section
13 Boom connection section
15 Front coupling device
16 Coupling mouth
17 Rear coupling device
18 Ball head coupling
19 Actuator
20 Chassis
21 Wheel
22 Track rod
24 Boom arm
25 Raking rotor
26 Arm
27 Tine
28 Auxiliary chassis
30 Steering rod
31 Steering actuator
35 Input clutch
36 Gearbox arrangement
37 PTO shaft
38 Transfer gearbox
39 Extension shaft
40 Longitudinal shaft
41 Output clutch
43 Force sensor
45 Swather control unit
50 Tractor
60 Baler
61 Baler control unit
63 Ground
64 Deposit area
65 Swath
A Coupling point
B Coupling point
C Boom swivel axes
D₁ Ground clearance of the longitudinal section (12)
D₂ Minimum ground clearance of the coupling points (A, B)
X Longitudinal axis
Y Transverse axis
Z Vertical axis

1-15. (canceled)

16. A swather comprising:
a frame;
a chassis which supports the frame;
at least one processing member which is configured to grip a crop material, the at least one processing member being connected at least indirectly to the frame;
a front coupling device which is arranged at a front side of the frame with respect to a longitudinal axis of the swather, the front coupling device defining a front coupling point for attaching the swather to a tractor; and
a rear coupling device which is arranged at a rear side of the frame with respect to the longitudinal axis, the rear coupling device defining a rear coupling point for attaching a baler to the swather.

17. The swather as recited in claim 16, wherein,
the swather is a rotary rake, and
the at least one processing member of the swather is at least one raking rotor.

18. The swather as recited in claim 16, wherein the rear coupling device is adjustable so that the rear coupling point is displaceable relative to the frame with respect to the longitudinal axis.

19. The swather as recited in claim 18, wherein the rear coupling point is further displaceable with respect to the chassis with respect to the longitudinal axis.

20. The swather as recited in claim 16, wherein the frame comprises a longitudinal section which extends along the longitudinal axis and which connects the front coupling device to the rear coupling device.

21. The swather as recited in claim 20, wherein,
the front coupling point has a minimum ground clearance,
the rear coupling point has a minimum ground clearance, and
the longitudinal section has a ground clearance which is at most 50% greater than the minimum ground clearance of the front coupling point and the minimum ground clearance of the rear coupling point.

22. The swather as recited in claim 20, wherein,
the longitudinal section has a length, and
at least 80% of the length of the longitudinal section extends at an angle of at most 10° to the longitudinal axis.

23. The swather as recited in claim 20, further comprising:
at least one boom arm which is connected to the frame,
wherein,
at least one of the at least one processing member is arranged on a respective one of the at least one boom arm.

24. The swather as recited in claim 23, wherein,
the frame comprises a boom connecting section,
the at least one boom arm is connected to the boom connecting section of the frame, and
the at least one boom arm projects upwards from the longitudinal section with respect to a vertical axis so that the at least one boom arm is higher than the longitudinal section at least in a region of the boom connecting section.

25. The swather as recited in claim 20, further comprising:
an input clutch for a drive connection to a power take-off shaft of the tractor; and
an output clutch which is configured to be coupled to the input clutch at least in a force-transmitting manner and for a drive connection to the baler.

26. The swather as recited in claim 25, further comprising:
a gear arrangement,
wherein,
the gear arrangement is configured to couple the at least one processing member to the input clutch in a force-transmitting manner, and
the gear arrangement is configured to couple the output clutch to the input clutch in the force-transmitting manner.

27. The swather as recited in claim 25, further comprising:
a longitudinal shaft which is substantially arranged within the frame, the longitudinal shaft being configured for a power transmission from the input clutch to the output clutch.

28. The swather as recited in claim 27, wherein the longitudinal shaft is substantially arranged within the longitudinal section of the frame.

29. The swather as recited in claim 25, wherein the output clutch is connected to the rear coupling device so that a relative position of the output clutch vis-à-vis the rear coupling point with respect to the longitudinal axis is independent of a setting of the rear coupling device.

30. The swather as recited in claim 25, wherein the output clutch is arranged offset forwards by between 10 cm and 20 cm vis-á-vis the rear coupling point with respect to the longitudinal axis.

31. The swather as recited in claim 16, wherein the chassis is configured so that a braking force is exertable thereon which is adjustable between a weaker single mode setting when the baler is coupled to the swather and a stronger combined mode setting when the swather is coupled to the baler.

32. The swather as recited in claim 31, wherein the swather is configured to automatically set the stronger combined mode setting when the baler is coupled to the swather and to automatically set the weaker single mode setting when the baler is not coupled to the swather.
